(19) United States
(12) Patent Application Publication
(10) Pub. No.: US 2026/0307430 A1
(43) Pub. Date: Oct. 8, 2026

(54) WHEEL CAP

(71) Applicant: KABUSHIKI KAISHA TOKAI-RIKA-DENKI-SEISAKUSHO, Niwa-gun, Aichi (JP)

(72) Inventors: Keisuke MATOBA, Niwa-gun, Aichi (JP); Masahiro HONDA, Niwa-gun, Aichi (JP); Satoshi ITO, Niwa-gun, Aichi (JP)

(73) Assignee: KABUSHIKI KAISHA TOKAI-RIKA-DENKI-SEISAKUSHO, Niwa-gun, Aichi (JP)

(21) Appl. No.: 19/485,195

(22) PCT Filed: May 9, 2024
(86) PCT No.: PCT/JP2024/017291

§ 371 Date: Nov. 17, 2025

(30) Foreign Application Priority Data
May 22, 2023 (JP) 2023-084022

(51) Int. Cl. B60B 7/08; B60B 7/02

(52) U.S. Cl. CPC B60B 7/08; B60B 7/02

(57) ABSTRACT

In a wheel cap, an insertion portion of a cap body is inserted into an insertion hole between spokes of a wheel. A first engagement surface of the insertion portion is engaged with the spoke to restrict displacement of the insertion portion with respect to the insertion hole, and a second engagement surface of the insertion portion is engaged with a restricting surface of the spoke to restrict detachment of the insertion portion from the insertion hole. The first engagement surface and the second engagement surface are provided on the spoke side of the insertion portion. Therefore, the degree of freedom in configuration of the insertion portion on a side opposite to the spoke can be increased.

### TECHNICAL FIELD

The present invention relates to a wheel cap in which a cap body covers a wheel.

### BACKGROUND ART

In the cap disclosed in Japanese Patent Application Laid-Open (JP-A) No. 2016-193693, a pair of cover bodies is inserted into the through hole of the wheel.

Here, in this cap, the pair of cover bodies is engaged with one side and the other side of the through hole.

### SUMMARY OF INVENTION

### Technical Problem

In view of the above fact, an object of the invention is to obtain a wheel cap capable of increasing the degree of freedom in configuration of an insertion portion on the other side of an insertion hole.

### Solution to Problem

A wheel cap of a first aspect of the invention includes: a cap body covering a wheel at which a restricting portion provided with a restricting surface is provided on one side of an insertion hole; an insertion portion provided at the cap body and inserted into the insertion hole; a first engagement surface provided on one side of the insertion hole at the insertion portion and engaged with the restricting portion to restrict displacement of the insertion portion with respect to the insertion hole; and a second engagement surface provided on one side of the insertion hole at the insertion portion, inclined toward the restricting surface with respect to the first engagement surface, and engaged with the restricting surface to restrict detachment of the insertion portion from the insertion hole.

A wheel cap of a second aspect of the invention is the wheel cap of the first aspect of the invention in which the first engagement surface and the second engagement surface are provided at a same insertion part of the insertion portion.

A wheel cap of a third aspect of the invention is the wheel cap of the first aspect of the invention in which the first engagement surface is provided at a first insertion part of the insertion portion, and the second engagement surface is provided at a second insertion part of the insertion portion.

A wheel cap of a fourth aspect of the invention is the wheel cap of the third aspect of the invention in which the first insertion part and the second insertion part are separated from each other.

A wheel cap of a fifth aspect of the invention is the wheel cap of any one of the first to fourth aspects of the invention including a biasing portion biasing the first engagement surface and the second engagement surface toward one side of the insertion hole.

A wheel cap of a sixth aspect of the invention is the wheel cap of the fifth aspect of the invention in which a same biasing part of the biasing portion biases the first engagement surface and the second engagement surface.

A wheel cap of a seventh aspect of the invention is the wheel cap of the fifth aspect of the invention in which a first biasing part of the biasing portion biases the first engagement surface, and a second biasing part of the biasing portion biases the second engagement surface.

A wheel cap of an eighth aspect of the invention is the wheel cap of the seventh aspect of the invention in which the first biasing part and the second biasing part are separated from each other.

### Advantageous Effects of Invention

In the wheel cap of the first aspect of the invention, the cap body covers the wheel, and the insertion portion of the cap body is inserted into the insertion hole of the wheel. The insertion portion is provided with the first engagement surface on one side of the insertion hole, and the first engagement surface is engaged with the restricting portion on one side of the insertion hole of the wheel to restrict displacement of the insertion portion with respect to the insertion hole. The insertion portion is provided with the second engagement surface on one side of the insertion hole, and the second engagement surface is inclined toward the restricting surface of the restricting portion with respect to the first engagement surface so that the second engagement surface is engaged with the restricting surface to restrict detachment of the insertion portion from the insertion hole.

Here, as described above, the insertion portion is provided with the first engagement surface and the second engagement surface on one side of the insertion hole. Therefore, the necessity of engaging the other side of the insertion hole of the insertion portion with the wheel can be reduced, and the degree of freedom in configuration of the insertion portion on the other side of the insertion hole can be increased.

In the wheel cap of the second aspect of the invention, the first engagement surface and the second engagement surface are provided at the same insertion part of the insertion portion. Therefore, the configuration of the insertion portion can be simplified.

In the wheel cap of the third aspect of the invention, the first engagement surface is provided at the first insertion part of the insertion portion, and the second engagement surface is provided at the second insertion part of the insertion portion. Therefore, the first engagement surface can be favorably engaged with the restricting portion, and the second engagement surface can be favorably engaged with the restricting surface.

In the wheel cap of the fourth aspect of the invention, the first insertion part and the second insertion part are separated from each other. Therefore, the relative position between the first engagement surface and the second engagement surface can be easily adjusted.

In the wheel cap of the fifth aspect of the invention, the biasing portion biases the first engagement surface and the second engagement surface toward one side of the insertion hole. Therefore, the first engagement surface can be effectively engaged with the restricting portion, and the second engagement surface can be effectively engaged with the restricting surface.

In the wheel cap of the sixth aspect of the invention, the same biasing part of the biasing portion biases the first engagement surface and the second engagement surface. Therefore, the configuration of the biasing portion can be simplified.

In the wheel cap of the seventh aspect of the invention, the first biasing part of the biasing portion biases the first engagement surface, and the second biasing part of the biasing portion biases the second engagement surface. Therefore, the biasing portion can favorably bias the first engagement surface and the second engagement surface.

In the wheel cap of the eighth aspect of the invention, the first biasing part and the second biasing part are separated from each other. Therefore, the relative position between the first biasing part and the second biasing part can be easily adjusted.

### BRIEF DESCRIPTION OF DRAWING

FIG. 1A is a front view illustrating a wheel in a first embodiment of the invention as viewed from the front side.

FIG. 1B is a front view illustrating a wheel cap according to the first embodiment of the invention as viewed from the front side.

FIG. 2 is a perspective view illustrating the wheel cap according to the first embodiment of the invention as viewed from the back side.

FIG. 3 is a cross-sectional view (a cross-sectional view taken along line 3-3 in FIG. 2) illustrating the wheel cap according to the first embodiment of the invention as viewed from the lateral side.

FIG. 4A is a perspective view illustrating a main part of the wheel cap according to the first embodiment of the invention as viewed from the back side.

FIG. 4B is a cross-sectional view (a cross-sectional view taken along line 4B-4B in FIG. 4A) illustrating the main part of the wheel cap according to the first embodiment of the invention as viewed from the lateral side.

FIG. 5A is a cross-sectional view illustrating the main part of the wheel cap according to the first embodiment of the invention in a normal state as viewed from the lateral side.

FIG. 5B is a cross-sectional view illustrating the main part of the wheel cap according to the first embodiment of the invention in a case in which a displacement force to the front side is applied to the wheel cap, as viewed from the lateral side.

FIG. 6 is a perspective view illustrating a wheel cap according to a second embodiment of the invention as viewed from the back side.

FIG. 7A is a perspective view illustrating a main part of the wheel cap according to the second embodiment of the invention as viewed from the back side.

FIG. 7B is a perspective view illustrating a leaf spring of the wheel cap according to the second embodiment of the invention as viewed from the back side.

FIG. 8A is a cross-sectional view (a cross-sectional view taken along line 8A-8A in FIG. 7A) illustrating the main part of the wheel cap according to the second embodiment of the invention as viewed from the lateral side.

FIG. 8B is a cross-sectional view (a cross-sectional view taken along line 8B-8B in FIG. 7A) illustrating the main part of the wheel cap according to the second embodiment of the invention as viewed from the lateral side.

FIG. 9 is a perspective view illustrating a wheel cap according to a third embodiment of the invention as viewed from the back side.

FIG. 10 is a perspective view illustrating a main part of the wheel cap according to the third embodiment of the invention as viewed from the back side.

### DESCRIPTION OF EMBODIMENTS

### First Embodiment

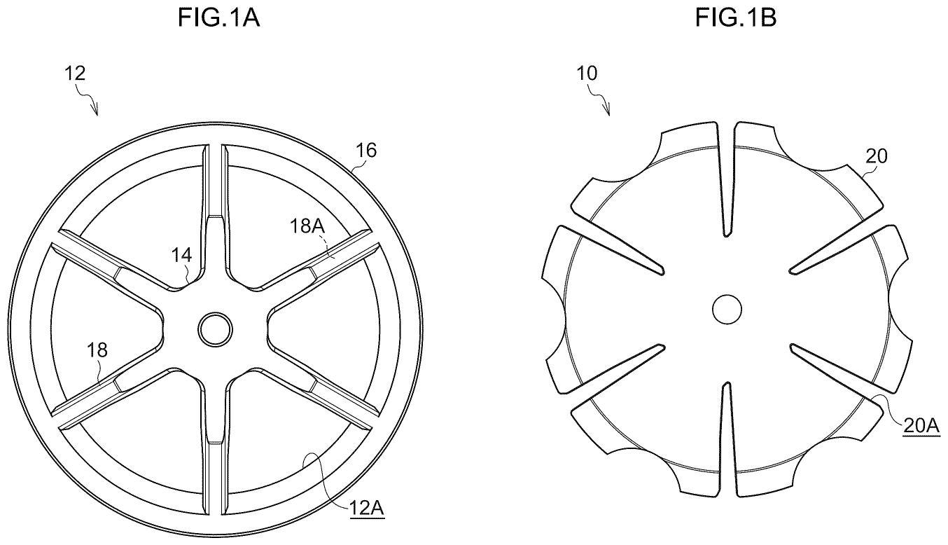

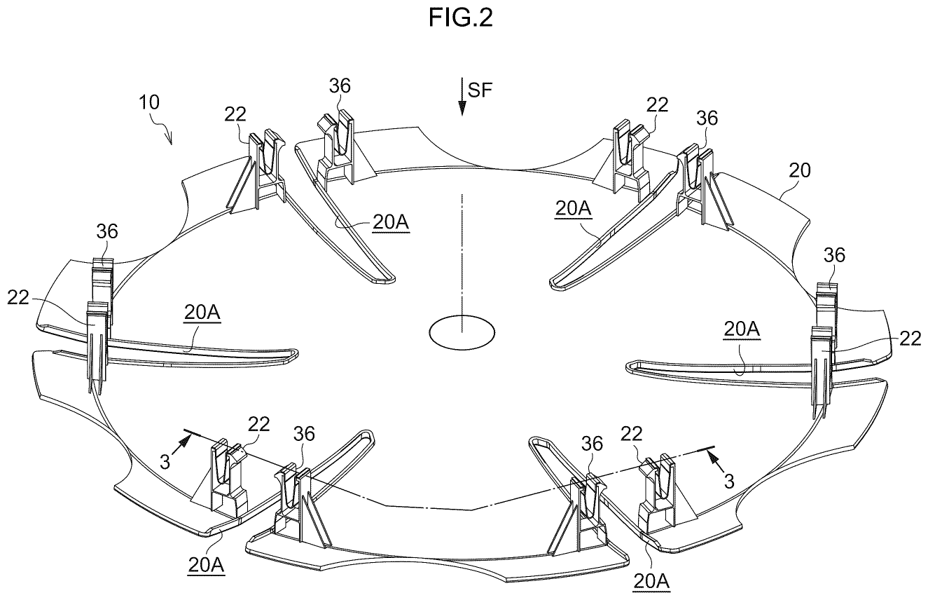

FIG. 1A is a front view of a wheel 12 in a first embodiment of the invention as viewed from the front side, and FIG. 1B is a front view of a wheel cap 10 according to the first embodiment of the invention as viewed from the front side. FIG. 2 is a perspective view of the wheel cap 10 as viewed from the back side. In the drawings, the front sides of the wheel 12 and the wheel cap 10 are indicated by arrows SF.

The wheel 12 in this embodiment is provided in a vehicle (automobile), and the front side of the wheel 12 is directed to the outside in a width direction of the vehicle.

As illustrated in FIG. 1A, a polygonal plate-shaped (substantially hexagonal plate-shaped in this embodiment) coupling portion 14 is coaxially provided at a central portion on the front side of the wheel 12, and the coupling portion 14 is coupled to a hub (not illustrated) of the vehicle. A substantially cylindrical rim portion 16 is coaxially provided on the outer peripheral portion of the wheel 12, and a tire is attached to the outer periphery of the rim portion 16.

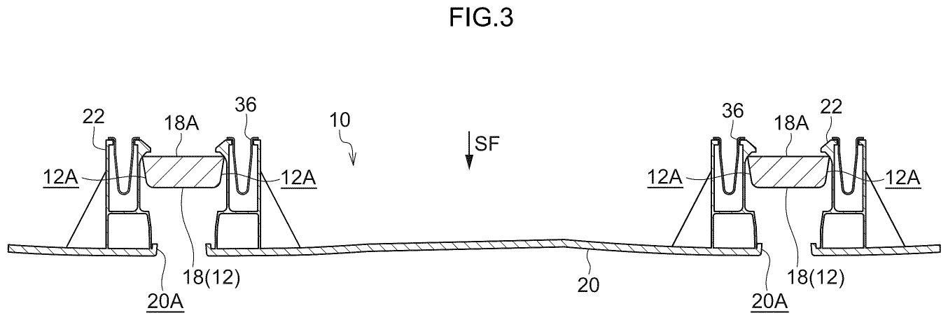

The wheel 12 is provided with a plurality of (six in this embodiment) spokes 18 as restricting portions between the coupling portion 14 and the rim portion 16, and the spokes 18 extend in the radial direction of the wheel 12. The spokes 18 connect the coupling portion 14 and the rim portion 16, and the plurality of spokes 18 are arranged at equal intervals in the circumferential direction of the wheel 12. The spoke 18 has a substantially trapezoidal cross section (see FIG. 3), and the front side surface and the back side surface of the spoke 18 are arranged perpendicular to the front and back direction. The circumferential dimension of the wheel 12 on the back side surface of the spoke 18 is larger than the circumferential dimension of the wheel 12 on the front side surface of the spoke 18, and the back side surface of the spoke 18 is a restricting surface 18A. A plurality of (six in this embodiment) substantially fan-shaped insertion holes 12A are formed through the wheel 12, and the coupling portion 14, the rim portion 16, and a pair of spokes 18 are disposed around the insertion holes 12A.

The wheel cap 10 according to this embodiment is attached to the front side of the wheel 12, and the front side of the wheel cap 10 is directed outward in the width direction of the vehicle.

As illustrated in FIGS. 1B and 2, the wheel cap 10 is provided with a cap body 20 made of a resin and having a substantially disk shape as a main body portion (design portion), and the cap body 20 is disposed coaxially with the wheel 12. The cap body 20 covers the front side of the wheel 12 (including the plurality of insertion holes 12A), and the cap body 20 is in contact with the front side of the wheel 12. A plurality of (six in this embodiment) elongated exposure holes 20A are formed through the cap body 20, and the exposure holes 20A extend radially outward from the outer periphery of the central portion of the cap body 20 and are opened radially outward of the cap body 20. The plurality of exposure holes 20A are arranged at equal intervals in the circumferential direction of the cap body 20, and the exposure holes 20A expose the spokes 18 of the wheel 12 to the front side.

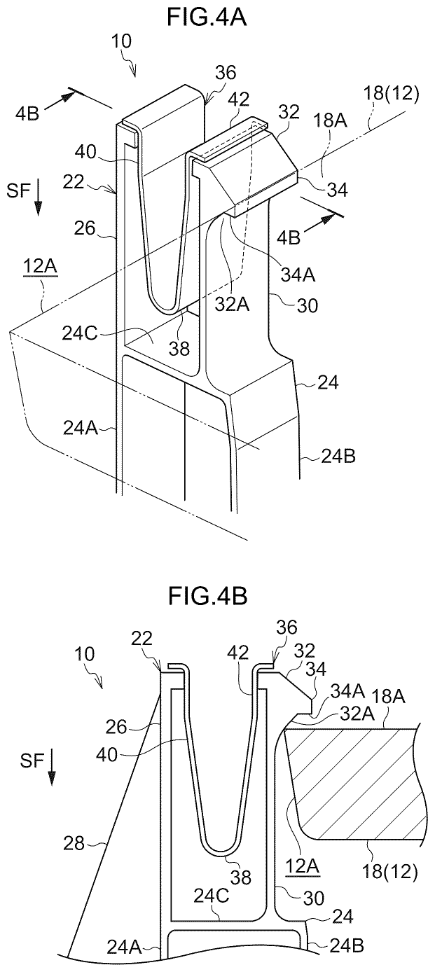

A plurality of (12 in this embodiment) insertion portions 22 (see FIGS. 3, 4A, and 4B) are integrally formed in the cap body 20, and the insertion portions 22 protrude toward the back side of the cap body 20 in the vicinity of the outer periphery of the cap body 20. The insertion portions 22 are disposed on both sides of the exposure hole 20A in the circumferential direction of the cap body 20, and the insertion portions 22 face each other across the exposure hole 20A in the circumferential direction of the cap body 20. The insertion portion 22 is inserted into the insertion hole 12A of the wheel 12 from the front side, and the insertion portions 22 face each other across the spokes 18 of the wheel 12 in the circumferential direction of the wheel 12.

A plate-shaped base 24 having a U-shaped cross section is provided at a proximal end side portion of the insertion portion 22. An inner wall 24A and an outer wall 24B each having a rectangular plate shape are provided on a side of the base 24 opposite to the exposure hole 20A and on the exposure hole 20A side, and the inner wall 24A and the outer wall 24B are integrated with the cap body 20 and are arranged perpendicular to the circumferential direction of the cap body 20. A rectangular plate-shaped top wall 24C is provided on a side of the base 24 opposite to the cap body 20, and the top wall 24C is disposed perpendicular to the front and back direction of the cap body 20.

A rectangular plate-shaped support plate 26 as a support portion is provided at a distal end side portion of the insertion portion 22, and the support plate 26 is disposed perpendicular to the circumferential direction of the cap body 20. The support plate 26 protrudes from the end portion of the base 24 on a side opposite to the exposure hole 20A to the back side of the cap body 20, and the surface of the support plate 26 on a side opposite to the exposure hole 20A is flush with the surface of the inner wall 24A of the base 24 on a side opposite to the exposure hole 20A. The distal end edge of the support plate 26 protrudes toward the exposure hole 20A.

A predetermined number (two in this embodiment) of reinforcing plates 28 having a right triangular plate shape as reinforcing portions are provided in a portion of the insertion portion 22 on a side opposite to the exposure hole 20A, and the reinforcing plates 28 are integrated with the cap body 20. The reinforcing plates 28 are disposed perpendicular to the radial direction of the cap body 20, and the predetermined number of reinforcing plates 28 are arranged in the radial direction of the cap body 20. The reinforcing plates 28 are integrated with the base 24 and the support plate 26 on a side opposite to the exposure hole 20A and extend to the distal end or the vicinity of the distal end of the support plate 26, and the reinforcing plates 28 reinforce the base 24 and the support plate 26 to restrict deformation of the base 24 and the support plate 26 to a side opposite to the exposure hole 20A.

An engaging claw 30 having a substantially rectangular plate shape as an engagement portion is provided in a distal end side portion of the insertion portion 22, and the engaging claw 30 is disposed perpendicular to the circumferential direction of the cap body 20. The engaging claw 30 protrudes from the portion of the base 24 on the exposure hole 20A side to the back side of the cap body 20, and the thickness dimension of the proximal end portion of the engaging claw 30 is gradually increased toward the base 24 on both sides in the thickness direction of the engaging claw 30. The distal end edge of the engaging claw 30 protrudes to the side opposite to the exposure hole 20A.

A first claw portion 32 having a substantially trapezoidal columnar shape as a first engagement portion is integrally formed at a distal end portion of the engaging claw 30, and the first claw portion 32 protrudes toward the exposure hole 20A and extends in the width direction of the engaging claw 30. A surface of the first claw portion 32 on a side opposite to the cap body 20 is inclined in a direction toward the cap body 20 as it goes toward the exposure hole 20A. A surface of the first claw portion 32 on the cap body 20 side is a first engagement surface 32A, and the first engagement surface 32A is inclined in a direction toward the opposite side to the cap body 20 as it goes toward the exposure hole 20A side. The first engagement surface 32A is engaged with (in line contact with) the back side (the restricting surface 18A side) of the spoke 18 of the wheel 12 and the corner portion on the insertion hole 12A side, and accordingly, a displacement force to the back side (the wheel 12 side) is applied to the wheel cap 10 to restrict rattling (displacement) of the wheel cap 10 with respect to the wheel 12, so that the wheel cap 10 is attached to the wheel 12.

A second claw portion 34 having a substantially trapezoidal columnar shape as a second engagement portion is integrally formed on the distal end portion of the engaging claw 30 on the exposure hole 20A side of the first claw portion 32, and the second claw portion 34 protrudes to the exposure hole 20A side and extends in the width direction of the engaging claw 30. A surface of the second claw portion 34 on a side opposite to the cap body 20 is flush with the surface of the first claw portion 32 on a side opposite to the cap body 20, and is inclined in a direction toward the cap body 20 as it goes toward the exposure hole 20A. A surface of the second claw portion 34 on the cap body 20 side is a second engagement surface 34A, and the second engagement surface 34A protrudes from the first engagement surface 32A of the first claw portion 32 to the exposure hole 20A side. The second engagement surface 34A is disposed substantially perpendicular to the front and back direction of the cap body 20 (substantially parallel to the restricting surface 18A) on the back side of the restricting surface 18A of the spoke 18, and the second engagement surface 34A is inclined toward the restricting surface 18A with respect to the first engagement surface 32A.

A plate-shaped leaf spring 36 (see FIGS. 3, 4A, and 4B) made of a metal and having a substantially U-shaped cross section as a biasing portion is attached to a distal end side portion of the insertion portion 22, and the leaf spring 36 is disposed between the support plate 26 of the insertion portion 22 and the engaging claw 30. The proximal end portion (end portion on the cap body 20 side) of the leaf spring 36 is a plate-shaped proximal end plate 38 having a U-shaped cross section, and the proximal end plate 38 is curved and protrudes toward the cap body 20 side. A portion of the leaf spring 36 on the support plate 26 side is an inner plate 40 having a substantially rectangular plate shape, a portion of the leaf spring 36 on the engaging claw 30 side is an outer plate 42 having a substantially rectangular plate shape, and proximal ends (ends on the cap body 20 side) of the inner plate 40 and the outer plate 42 are connected to the proximal end plate 38. Portions other than the distal end portions (end portions on a side opposite to the cap body 20) of the inner plate 40 and the outer plate 42 extend in directions toward the support plate 26 and the engaging claw 30 as it goes toward the opposite side to the cap body 20, respectively, and portions other than the distal end edges of the distal end portions of the inner plate 40 and the outer plate 42 are arranged substantially perpendicular to the circumferential direction of the cap body 20 and are in contact with the distal end edge of the support plate 26 and the distal end edge of the engaging claw 30, respectively. The leaf spring 36 is elastically deformed in a direction in which the inner plate 40 and the outer plate 42 approach each other between the support plate 26 and the engaging claw 30, and the leaf spring 36 biases the engaging claw 30 toward the spoke 18 in the outer plate 42. The distal end edges of the inner plate 40 and the outer plate 42 are bent toward the support plate 26 and the engaging claw 30, respectively, and the distal end edges of the inner plate 40 and the outer plate 42 are disposed perpendicular to the front and back direction of the cap body 20.

Next, the operation of this embodiment will be described.

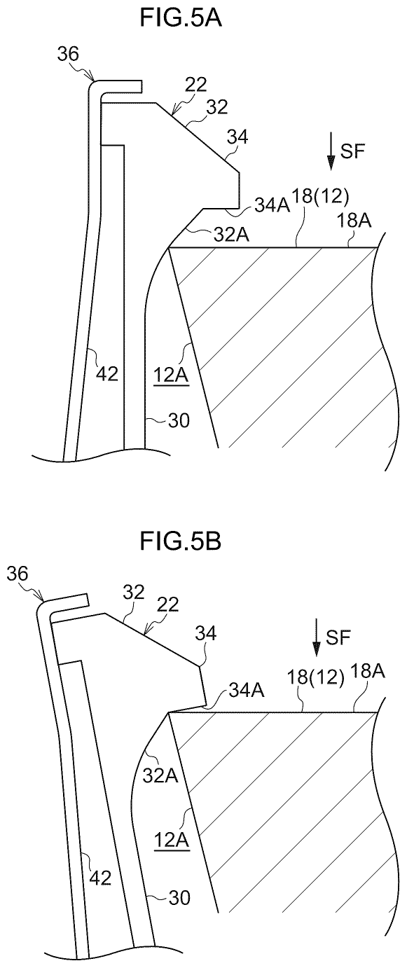

In the wheel cap 10 having the above configuration, the insertion portion 22 of the cap body 20 is inserted into the insertion hole 12A between the spokes 18 of the wheel 12. The engaging claw 30 is provided on the spoke 18 side (one side of the insertion hole 12A) of the insertion portion 22, and the first claw portion 32 (including the first engagement surface 32A) and the second claw portion 34 (including the second engagement surface 34A) are provided in the engaging claw 30. The first engagement surface 32A of the first claw portion 32 is engaged with the spoke 18 (see FIG. 5A), and displacement of the insertion portion 22 with respect to the insertion hole 12A is restricted, so that rattling of the wheel cap 10 with respect to the wheel 12 is restricted.

In a case in which the displacement force to the front side is applied to the wheel cap 10 and the insertion portion 22 is displaced to the front side of the wheel 12, the second engagement surface 34A of the second claw portion 34 is engaged with the restricting surface 18A of the spoke 18 (see FIG. 5B), and the detachment of the insertion portion 22 from the insertion hole 12A is restricted, so that the detachment of the wheel cap 10 from the wheel 12 is restricted. In a case in which the second engagement surface 34A is engaged with the restricting surface 18A, the inclination angle of the second engagement surface 34A with respect to the restricting surface 18A toward the back side of the wheel 12 is preferably, for example, 20° or less, and the second engagement surface 34A may be inclined to the front side of the wheel 12 by 0° or more with respect to the restricting surface 18A.

Here, as described above, the insertion portion 22 is provided with the first engagement surface 32A and the second engagement surface 34A in the engaging claw 30 on the spoke 18 side. Therefore, the necessity of engaging the support plate 26 on the side of the insertion portion 22 opposite to the spoke 18 (the other side of the insertion hole 12A) with the wheel 12 can be reduced, the necessity of providing the claw portion on the support plate 26 can be reduced, and the degree of freedom in configuration of the support plate 26 can be increased. The necessity of providing a portion to be engaged with the support plate 26 in the insertion hole 12A can be reduced, and the degree of freedom in configuration of the wheel 12 to which the wheel cap 10 is attached can be increased. The necessity of providing a separate member (tape or the like) for restricting rattling of the wheel cap 10 with respect to the wheel 12 can be reduced, and the number of assembling steps and cost can be reduced.

The first engagement surface 32A and the second engagement surface 34A are provided on the engaging claw 30 (the same insertion part) of the insertion portion 22. Therefore, the configuration of the insertion portion 22 can be simplified.

The outer plate 42 of the leaf spring 36 biases the first engagement surface 32A and the second engagement surface 34A of the engaging claw 30 toward the spoke 18. Therefore, the first engagement surface 32A can be effectively engaged with the spoke 18, the displacement of the insertion portion 22 with respect to the insertion hole 12A can be effectively restricted, and the second engagement surface 34A can be effectively engaged with the restricting surface 18A, so that the detachment of the insertion portion 22 from the insertion hole 12A can be effectively restricted.

The outer plate 42 (the same biasing part) of the leaf spring 36 biases the first engagement surface 32A and the second engagement surface 34A of the engaging claw 30. Therefore, the configuration of the leaf spring 36 can be simplified.

In the insertion portion 22, the engaging claw 30 is integrated with the base 24 and is not integrated with the cap body 20. Therefore, the protruding dimension of the engaging claw 30 toward the wheel 12 can be reduced, and the occurrence of sink marks due to the engaging claw 30 can be suppressed on the front side surface (design surface) of the cap body 20 at the time of molding the wheel cap 10.

### Second Embodiment

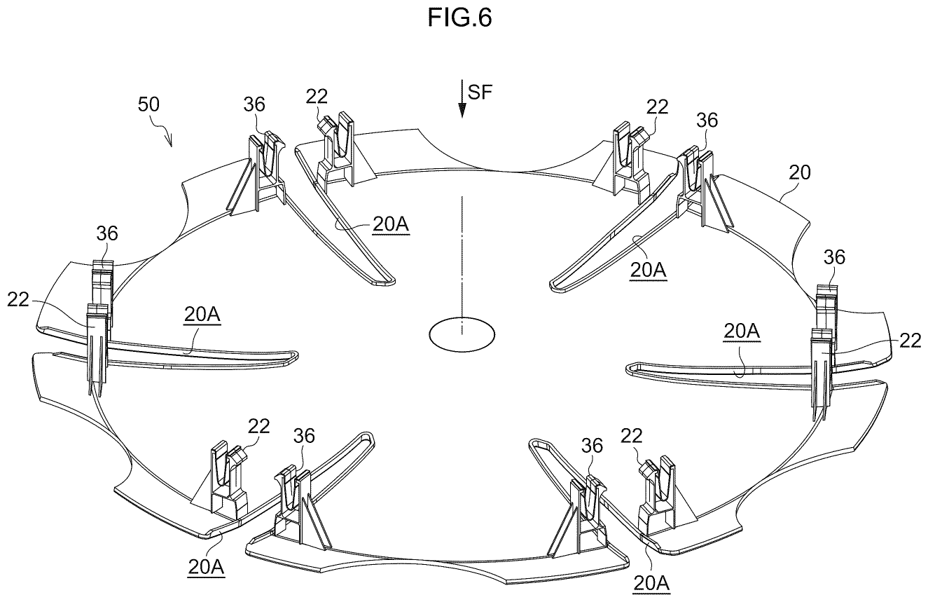

FIG. 6 is a perspective view of a wheel cap 50 according to a second embodiment of the invention as viewed from the back side.

The wheel 12 in this embodiment has the same configuration as that of the first embodiment.

The wheel cap 50 according to this embodiment has substantially the same configuration as that of the first embodiment, but differs in the following points.

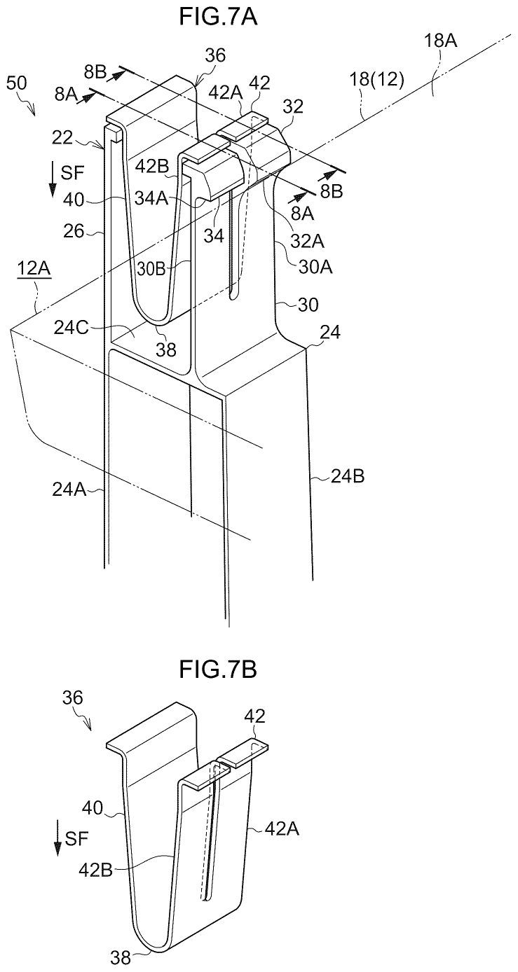

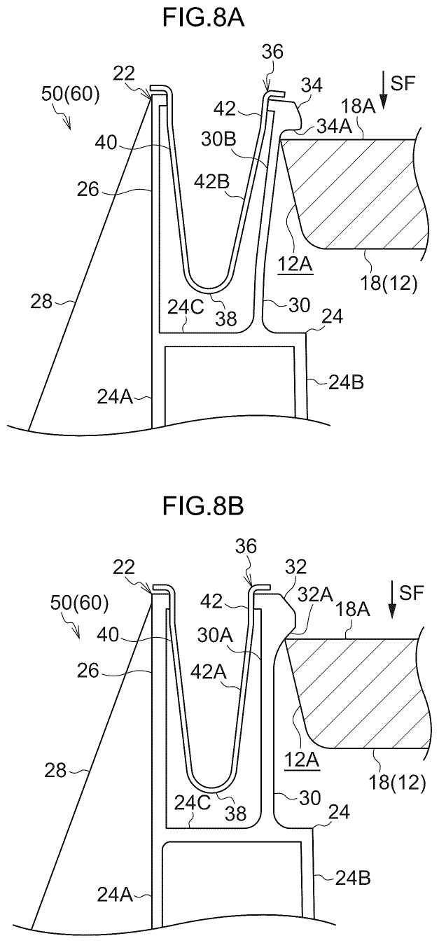

As illustrated in FIG. 6, in the wheel cap 50 according to this embodiment, in the insertion portion 22, a portion other than the proximal end portion of the engaging claw 30 is divided into the first claw 30A (see FIGS. 7A and 8B) on the radially inner side of the cap body 20 and the second claw 30B (see FIGS. 7A and 8A) on the radially outer side of the cap body 20. The first claw portion 32 (including the first engagement surface 32A) is integrally formed with the distal end portion of the first claw 30A, and the second claw portion 34 (including the second engagement surface 34A) is integrally formed with the distal end portion of the second claw 30B.

A portion of the leaf spring 36 other than the proximal end portion of the outer plate 42 is divided into a first spring 42A on the radially inner side of the cap body 20 and a second spring 42B on the radially outer side of the cap body 20 (see FIG. 7B). The first spring 42A biases the first claw 30A of the engaging claw 30 toward the spoke 18 (see FIGS. 7A and 8B). The second spring 42B is bent by biasing the second claw 30B of the engaging claw 30 toward the spoke 18, so that the proximal end side portion is brought into contact (line contact) with the back side (restricting surface 18A side) of the spoke 18 and the corner portion on the insertion hole 12A side by the second claw portion 34 of the second claw 30B (see FIGS. 7A and 8A).

Here, also in this embodiment, it is possible to achieve the same operations and effects as those of the first embodiment except for the operations and effects obtained in a case in which the engaging claw 30 of the insertion portion 22 and the outer plate 42 of the leaf spring 36 are not divided.

In the insertion portion 22, the first engagement surface 32A is provided on the first claw 30A (first insertion part) of the engaging claw 30, and the second engagement surface 34A is provided on the second claw 30B (second insertion part) of the engaging claw 30. Therefore, the first engagement surface 32A can be favorably engaged with the restricting surface 18A of the spoke 18, and the second engagement surface 34A can be favorably engaged with the restricting surface 18A.

The first spring 42A (first biasing part) of the leaf spring 36 biases the first engagement surface 32A, and the second spring 42B (second biasing part) of the leaf spring 36 biases the second engagement surface 34A. Therefore, the leaf spring 36 can favorably bias the first engagement surface 32A and the second engagement surface 34A by the first spring 42A and the second spring 42B. The first spring 42A and the second spring 42B are coupled to each other in the leaf spring 36, so that an increase in the number of components can be suppressed.

In the engaging claw 30, the second claw 30B (second engagement surface 34A) is disposed radially outward of the cap body 20 with respect to the first claw 30A (first engagement surface 32A). Therefore, in a case in which the displacement force to the front side is applied to the outer periphery of the cap body 20 and the cap body 20 is tilted, the torque with which the second engagement surface 34A is engaged with the restricting surface 18A of the spoke 18 can be increased, the detachment of the insertion portion 22 from the insertion hole 12A can be effectively restricted, and the detachment of the wheel cap 50 from the wheel 12 can be effectively restricted.

### Third Embodiment

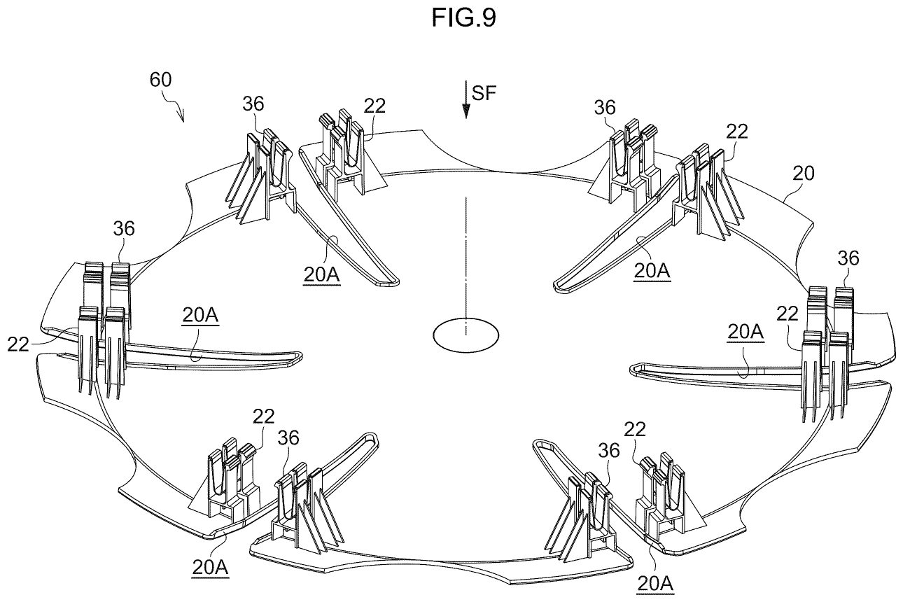

FIG. 9 is a perspective view of a wheel cap 60 according to a third embodiment of the invention as viewed from the back side.

The wheel 12 in this embodiment has the same configuration as that of the first embodiment.

The wheel cap 60 according to this embodiment has substantially the same configuration as that of the second embodiment, but differs in the following points.

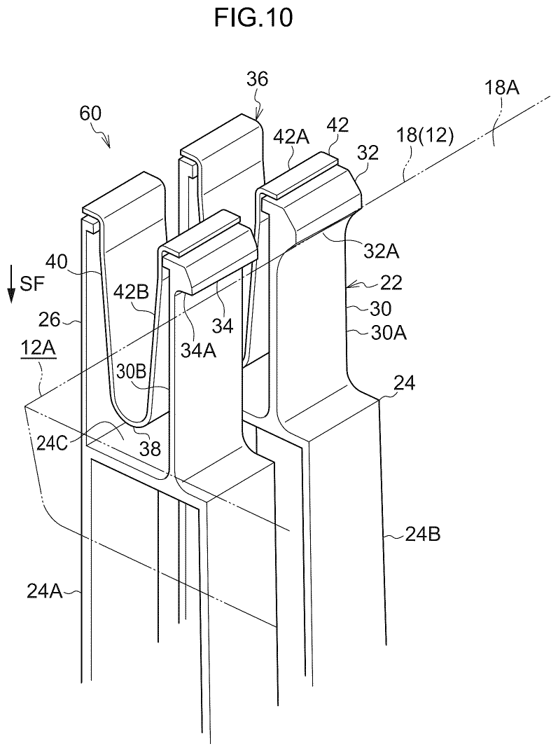

As illustrated in FIG. 9, in the wheel cap 60 according to this embodiment, the insertion portion 22 is separated into a radially inner portion of the cap body 20 and a radially outer portion of the cap body 20 (see FIG. 10), and the engaging claw 30 of the insertion portion 22 is separated into the first claw 30A (see FIG. 8B) on the radially inner side of the cap body 20 and the second claw 30B (see FIG. 8A) on the radially outer side of the cap body 20.

The leaf spring 36 is separated into a radially inner portion of the cap body 20 and a radially outer portion of the cap body 20 (see FIG. 10), and the outer plate 42 of the leaf spring 36 is separated into the first spring 42A (see FIG. 8B) on the radially inner side of the cap body 20 and the second spring 42B (see FIG. 8A) on the radially outer side of the cap body 20.

Here, also in this embodiment, it is possible to achieve the same operations and effects as those of the second embodiment except for the operations and effects by coupling the first spring 42A and the second spring 42B of the leaf spring 36.

The first claw 30A (first insertion part) and the second claw 30B (second insertion part) of the engaging claw 30 of the insertion portion 22 are separated from each other. Therefore, the relative position between the first claw 30A (first engagement surface 32A) and the second claw 30B (second engagement surface 34A) can be easily adjusted.

The first spring 42A (first biasing part) and the second spring 42B (second biasing part) of the outer plate 42 of the leaf spring 36 are separated from each other. Therefore, the relative position between the first spring 42A and the second spring 42B can be easily adjusted.

In the second embodiment and the third embodiment, in the engaging claw 30 of the insertion portion 22, the second claw 30B (second engagement surface 34A) is disposed on the radially outer side of the cap body 20 with respect to the first claw 30A (first engagement surface 32A). However, in the engaging claw 30 of the insertion portion 22, the second claw 30B (second engagement surface 34A) may be disposed on the radially inner side of the cap body 20 with respect to the first claw 30A (first engagement surface 32A).

In the first to third embodiments, the cap body 20 is connected in the circumferential direction. However, the cap body 20 may be separated in the circumferential direction. In this case, the cap body 20 may be separated at the circumferential position of the exposure hole 20A.

The entire contents of the disclosures by Japanese Patent Application No. 2023-84022 filed on May 22, 2023 are incorporated herein by reference.

### DESCRIPTION OF REFERENCE NUMERALS

10 Wheel cap
12 Wheel
12A Insertion hole
18 Spoke (restricting portion)
18A Restricting surface
20 Cap body
22 Insertion portion
30 Engaging claw (insertion part)
30A First claw (first insertion part)
30B Second claw (second insertion part)
32A First engagement surface
34A Second engagement surface
36 Leaf spring (biasing portion)
42 Outer plate (biasing part)
42A First spring (first biasing part)
42B Second spring (second biasing part)
50 Wheel cap
60 Wheel cap

1. A wheel cap comprising:
a cap body covering a wheel at which a restricting portion provided with a restricting surface is provided on one side of an insertion hole;
an insertion portion provided at the cap body and inserted into the insertion hole;
a first engagement surface provided on one side of the insertion hole at the insertion portion and engaged with the restricting portion to restrict displacement of the insertion portion with respect to the insertion hole; and
a second engagement surface provided on one side of the insertion hole at the insertion portion, inclined toward the restricting surface with respect to the first engagement surface, and engaged with the restricting surface to restrict detachment of the insertion portion from the insertion hole.

2. The wheel cap according to claim 1, wherein the first engagement surface and the second engagement surface are provided at a same insertion part of the insertion portion.

3. The wheel cap according to claim 1, wherein the first engagement surface is provided at a first insertion part of the insertion portion, and the second engagement surface is provided at a second insertion part of the insertion portion.

4. The wheel cap according to claim 3, wherein the first insertion part and the second insertion part are separated from each other.

5. The wheel cap according to claim 1, comprising a biasing portion biasing the first engagement surface and the second engagement surface toward one side of the insertion hole.

6. The wheel cap according to claim 5, wherein a same biasing part of the biasing portion biases the first engagement surface and the second engagement surface.

7. The wheel cap according to claim 5, wherein a first biasing part of the biasing portion biases the first engagement surface, and a second biasing part of the biasing portion biases the second engagement surface.

8. The wheel cap according to claim 7, wherein the first biasing part and the second biasing part are separated from each other.

9. The wheel cap according to claim 1, comprising a base provided on the cap body side of the insertion portion and supporting at least one of the first engagement surface or the second engagement surface.

10. The wheel cap according to claim 1, wherein the second engagement surface is disposed further toward a radial direction outer side of the wheel than the first engagement surface.
